(19) United States
(12) Patent Application Publication
(10) Pub. No.: US 2002/0148136 A1
(43) Pub. Date: Oct. 17, 2002

(54) Dryer bag

(76) Inventor: Annie K. Wilson, Landsdowne, PA (US)

Correspondence Address: Weiner & Burt, P.C., P.O. Box 186, 635 N. US-23, Harrisville, MI, 48740, US

(21) Appl. No.: 10/081,169

(22) Filed: Feb. 21, 2002

Related U.S. Application Data
(60) Provisional application No. 60/270,454, filed on Feb. 22, 2001.

(51) Int. Cl. F26B 25/00

(52) U.S. Cl. 34/104

(57) ABSTRACT

A bag for drying sneakers, other casual shoes, or casual wear in a clothes dryer. The bag is padded to minimize noise, and perforated to assist in drying the contents thereof. A viewing window is optionally provided.

The present utility patent application is based on and claims priority from United States Provisional Patent Application Serial No. 60/270,454 filed on Feb. 22, 2001.

The present invention relates generally to certain new and useful improvements in dryer bags.

More particularly, the present invention relates to a novel dryer bag for drying sneakers, shoes, and/or other items in a clothes dryer.

### BACKGROUND OF THE INVENTION

In the past various attempts have been made to try to dry wet sneakers and shoes in a clothes dryer. Such attempts have been unsuccessful and have been accompanied by various problems, including excessive noise and vibrations, and very long time periods to accomplish drying.

### DESCRIPTION OF THE RELEVANT ART

The relevant art is exemplified by the following United States patents:

U.S. Pat. No. 4,702,016 issued in 1987 to Grigsby et al. entitled “APPARATUS FOR DRYING SHOES IN A DRYER”;

U.S. Pat. No. 4,843,730 issued in 1989 to Grant et al. entitled “METHOD AND APPARATUS FOR DRYING ATHLETIC BALLS”;

U.S. Pat. No. 5,333,393 issued in 1994 to Hill et al. entitled “SHOE RETAINING APPARATUS AND METHOD”;

U.S. Pat. No. 5,398,428 issued in 1995 to Wallace entitled “SHOE DRYER BRACKET”;

U.S. Pat. No. 5,623,769 issued in 1997 to Hayden entitled “DEVICE FOR DRYING OBJECTS IN A DRYER OF CLOTHES”.

It is a desideratum of the present invention to avoid the animadversions of the above-described prior art techniques and devices.

### SUMMARY OF THE INVENTION

The present invention provides a new and useful bag for drying wet items in a clothes dryer, comprising: a bag having an inner layer and an outer layer; said layers being perforated so that heated air in said clothes dryer will flow around the interior of said bag and dry said wet items placed in said bag; and said bag being of sufficient thickness to withstand the rigors of being used again and again in said clothes dryer, thus providing durability.

It is, therefore, one of the primary objects of the present invention to provide a novel dryer bag which achieves the drying of sneakers, other athletic shoes, casual ware, or the like in record time.

It is another object of the present invention to provide a novel dryer bag as described hereinabove which is fabricated in a two-layer construction

It is a further object of the present invention to provide a novel dryer bag as described hereinabove that includes an inner layer which is made preferably, but not necessarily, of cotton or the like and which is perforated to enable the dryer heat to flow around the interior of the dryer bag.

Another object of the present invention is to provide a novel dryer bag as described hereinabove which includes an outer layer that retains the heat inside the dryer bag so that the sneakers and/or other items placed in said dryer bag will dry extremely quickly.

A further object of the present invention is to provide a novel and unique dryer bag as described above wherein the one-inch ply thickness of said dryer bag and the heavy-duty stitching thereof ensures that said dryer bag will withstand the rigors of being used again and again in the interior of said clothes dryer, thus providing durability.

An additional object of the present invention is to provide a novel and unique dryer bag as described above wherein the thick layered construction thereof also reduces the noise from said clothes dryer as the contents in said dryer bag and the items contained therein are being tossed about within said clothes dryer.

Another object of the present invention is to provide a new and useful dryer bag as described hereinabove wherein the back of the dryer bag is provided with at least on Velcro member to stick to the surface of the dryer to keep the bag from tossing about in the dryer and from hitting the dryer door causing possible damage.

Yet a further object of the present invention is to provide a bag as described hereinabove, wherein: said bag is designed in a substantially square shape; said bag is provided with a plurality of perforations which are large enough to permit heated air to enter said bag, but small enough to retain heated air within said bag; said bag is provided with heavy-duty stitching on each side thereof to prevent said bag from tearing while in use; said bag includes a closure member which may be provided with a strip of hook-and-loop material that mates with a complementary strip of hook-and loop material; and said inner layer consists of cotton.

The present invention possesses many other advantages and features which will become more apparent to those persons skilled in this area of technology and to others when reading the detailed description of one exemplary preferred embodiment of the present invention as set forth hereinbelow in conjunction with the accompanying drawings.

### BRIEF DESCRIPTION OF THE DRAWINGS

FIG. 1 is a perspective illustration of a preferred embodiment of the present invention, and depicting how the dryer bag appears when the bag closure is in an opened position.

FIG. 2 illustrates a front elevational view of the dryer bag depicted in FIG. 1.

FIG. 3 illustrates a back elevational view of the dryer bag depicted in FIG. 1.

FIG. 4 illustrates the inner components or layers of the dryer bag depicted in FIG. 1.

### DETAILED DESCRIPTION OF ONE PREFERRED EMBODIMENT

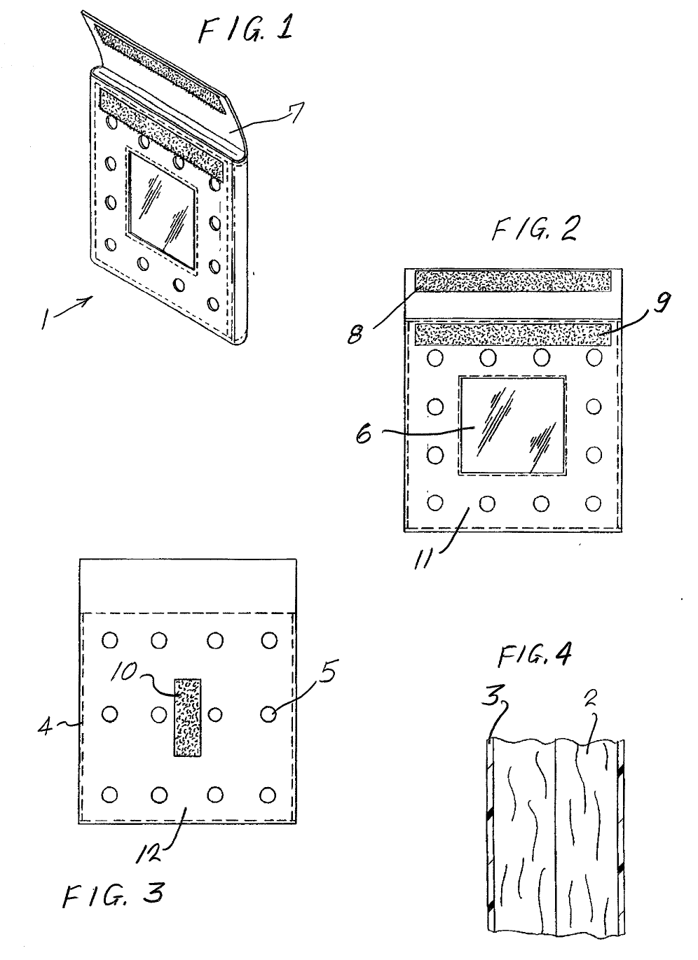

In accordance with a preferred embodiment of the present invention, there is provided, as illustrated in FIG. 1, a novel dryer bag 1 for quickly and quietly drying wet sneakers and/or other items in a clothes dryer.

The bag 1 includes an inner layer 2 and an outer layer 3.

The inner layer 2 preferably, but not necessarily, will consist of a durable padded material, such as cotton, which will muffle the noise but permit the contents of the bag 1 to dry in a reasonable time of about 10 to 15 minutes.

The outer layer 3 is fabricated from a suitable material which will get no hotter than clothes when they come out of the clothes dryer.

The bag 1 is preferably, but not necessarily, designed in a square shape of approximately 18 inches by 18 inches, and has a thickness of approximately 1 inch. The bag 1 is provided with heavy-duty stitching 4 on each side about 1 to 1.5 inches thick to prevent the bag 1 from tearing while in use. The edges of the stitching 4 should preferably, but not necessarily, appear inside the bag 1 behind the padded material so that it is not visible.

The bag 1 is provided with air holes or perforations 5 which should be large enough to permit heated air to enter the bag 1, but small enough to retain heated air in the bag 1, so that the sneakers or other wet items being dried will dry in record time of 15 minutes or less. Preferably, but not necessarily, the perforations 5 will be of button size of about ¼ inch to ½ inch in diameter.

The bag 1 may optionally be provided with a clear or transparent plastic viewing window 6 positioned in the central portion of the front side 11 of the bag 1 to see inside the bag 1. The window 6 is preferably, but not necessarily, square in shape of approximately 8 inches by 8 inches.

The bag 1 includes a closure member 7 which may be provided with a strip 8 of Velcro or other suitable hook-and-loop material. The strip 8 mates with a corresponding or complementary strip 9 of Velcro or other suitable hook-and-loop material.

Optionally, the bag is provided with means 10 for removably and selectively securing said bag 1 to an inner portion of said clothes dryer to keep said bag 1 from tossing about in said clothes dryer and from hitting a door of said clothes dryer causing possible damage.

In particular, the back 12 of the dryer bag 1 may be provided with at least one Velcro or other suitable hook-and-loop member 10 to stick to an interior surface of the clothes dryer to keep the bag 1 from tossing about in the dryer and from hitting the dryer door causing possible damage.

The present invention thus provides a vented and padded enclosure or bag 1 for wet athletic shoes and/or other wet items to permit the very rapid drying thereof, while reducing or eliminating the noise and vibration normally associated with loose sneakers tumbling inside a clothes dryer.

In addition, ordinarily when drying sneakers in a clothes dryer the laces will invariably come out of the eyelets. This does not occur when the sneakers are placed in the bag 1 of the present invention. With the present invention, the laces of the sneakers remain in the eyelets and the sneakers are constrained from moving around so loosely.

There has been illustrated in the accompanying drawings and described hereinabove only one unique and novel preferred embodiment of the present invention which can be constructed in many different configurations, arrangement of components, sizes, and shapes. It should be understood that many changes, modifications, variations, and other uses and applications will become apparent to those persons skilled in this particular area of technology and to others after having been exposed to the present specification and accompanying drawings.

Any and all such changes, modifications, variations, and other uses and applications which do not depart from the spirit and scope of the present invention are therefore covered by and embraced within the present invention and patent claims set forth hereinbelow.

1. A bag for drying wet items in a clothes dryer, comprising:
a bag having an inner layer and an outer layer;
said layers being perforated so that heated air in said clothes dryer will flow around the interior of said bag and dry said wet items placed in said bag; and
said bag being of sufficient thickness to withstand the rigors of being used again and again in said clothes dryer, thus providing durability.

2. A bag according to claim 1, wherein:
said bag includes means for removably and selectively securing said bag to an inner portion of said clothes dryer to keep said bag from tossing about in said clothes dryer and from hitting a door of said clothes dryer causing possible damage.

3. A bag according to claim 2, wherein:
said means includes hook-and-loop material.

4. A bag according to claim 1, wherein:
said inner layer includes a durable padded material to muffle noise but to permit said wet items to dry within a reasonable time.

5. A bag according to claim 1, wherein:
said inner layer includes a durable padded material to muffle noise but to permit said wet items to dry within ten to fifteen minutes..

6. A bag according to claim 2, wherein:
said inner layer includes a durable padded material to muffle noise but to permit said wet items to dry within a reasonable time.

7. A bag according to claim 1, wherein:
said outer layer is fabricated from a predetermined material which gets no hotter than clothes when they come out of said clothes dryer.

8. A bag according to claim 1, wherein:
said bag is provided with a transparent viewing window to permit viewing inside said bag.

9. A bag according to claim 2, wherein:
said bag is provided with a transparent viewing window to permit viewing inside said bag.

10. A bag according to claim 4, wherein:
said bag is provided with a transparent viewing window to permit viewing inside said bag.

11. A bag according to claim 5, wherein:
said bag is provided with a transparent viewing window to permit viewing inside said bag.

12. A bag according to claim 6, wherein:
said bag is provided with a transparent viewing window to permit viewing inside said bag.

13. A bag according to claim 1, wherein:
said bag is designed in a substantially square shape;
said bag is provided with a plurality of perforations which are large enough to permit heated air to enter said bag, but small enough to retain heated air within said bag;
said bag is provided with heavy-duty stitching on each side thereof to prevent said bag from tearing while in use;
said bag includes a closure member which may be provided with a strip of hook-and-loop material that mates with a complementary s trip of hook-and loop material; and
said inner layer consists of cotton.

14. A bag according to claim 2, wherein:
said bag is designed in a substantially square shape;
said bag is provided with a plurality of perforations which are large enough to permit heated air to enter said bag, but small enough to retain heated air within said bag;
said bag is provided with heavy-duty stitching on each side thereof to prevent said bag from tearing while in use;
said bag includes a closure member which may be provided with a strip of hook-and-loop material that mates with a complementary strip of hook-and loop material; and
said inner layer consists of cotton.

15. A bag according to claim 4, wherein:
said bag is designed in a substantially square shape;
said bag is provided with a plurality of perforations which are large enough to permit heated air to enter said bag, but small enough to retain heated air within said bag;
said bag is provided with heavy-duty stitching on each side thereof to prevent said bag from tearing while in use;
said bag includes a closure member which may be provided with a strip of hook-and-loop material that mates with a complementary strip of hook-and loop material; and
said inner layer consists of cotton.

16. A bag according to claim 5, wherein:
said bag is designed in a substantially square shape;
said bag is provided with a plurality of perforations which are large enough to permit heated air to enter said bag, but small enough to retain heated air within said bag;
said bag is provided with heavy-duty stitching on each side thereof to prevent said bag from tearing while in use;
said bag includes a closure member which may be provided with a strip of hook-and-loop material that mates with a complementary strip of hook-and loop material; and
said inner layer consists of cotton.

17. A bag according to claim 6, wherein:
said bag is designed in a substantially square shape;
said bag is provided with a plurality of perforations which are large enough to permit heated air to enter said bag, but small enough to retain heated air within said bag;
said bag is provided with heavy-duty stitching on each side thereof to prevent said bag from tearing while in use;
said bag includes a closure member which may be provided with a strip of hook-and-loop material that mates with a complementary strip of hook-and loop material; and
said inner layer consists of cotton.

18. A bag according to claim 7, wherein:
said bag is designed in a substantially square shape;
said bag is provided with a plurality of perforations which are large enough to permit heated air to enter said bag, but small enough to retain heated air within said bag;
said bag is provided with heavy-duty stitching on each side thereof to prevent said bag from tearing while in use;
said bag includes a closure member which may be provided with a strip of hook-and-loop material that mates with a complementary strip of hook-and loop material; and
said inner layer consists of cotton.

19. A bag according to claim 8, wherein:
said bag is designed in a substantially square shape;
said bag is provided with a plurality of perforations which are large enough to permit heated air to enter said bag, but small enough to retain heated air within said bag;
said bag is provided with heavy-duty stitching on each side thereof to prevent said bag from tearing while in use;
said bag includes a closure member which may be provided with a strip of hook-and-loop material that mates with a complementary strip of hook-and loop material; and
said inner layer consists of cotton.

20. A bag according to claim 9, wherein:
said bag is designed in a substantially square shape;
said bag is provided with a plurality of perforations which are large enough to permit heated air to enter said bag, but small enough to retain heated air within said bag;
said bag is provided with heavy-duty stitching on each side thereof to prevent said bag from tearing while in use;
said bag includes a closure member which may be provided with a strip of hook-and-loop material that mates with a complementary strip of hook-and loop material; and
said inner layer consists of cotton.
